(19) United States
(12) Patent Application Publication
(10) Pub. No.: US 2006/0140634 A1
(43) Pub. Date: Jun. 29, 2006

(54) LED security device and system

(76) Inventors: Robert Dell, Tappan, NY (US); Andrew Yang, Edison, NJ (US)

Correspondence Address: RICHARD I. SAMUEL;GOODWIN PROCTER L.L.P, 599 LEXINGTON AVE., NEW YORK, NY, 10022, US

(21) Appl. No.: 11/317,480

(22) Filed: Dec. 23, 2005

Related U.S. Application Data
(60) Provisional application No. 60/640,099, filed on Dec. 28, 2004.

(51) Int. Cl. H04B 10/00

(52) U.S. Cl. 398/106

(57) ABSTRACT

Provided herein are embodiments of an LED security system and method. In one exemplary embodiment, the present invention comprises: (a) a first device comprising means for generating light having specific wavelengths; and (b) a second device comprising: (i) a plurality of light emitting diodes capable of receiving light having specific wavelengths and generating corresponding first electrical signals; (ii) means for amplifying the first electrical signals; (iii) means for providing encoding logic, wherein the means for providing encoding logic receives the amplified first electrical signals, determines whether the amplified first electrical signals correspond to a predetermined encoded sequence, and provides at least a second signal if the amplified first electrical signals correspond to the predetermined encoded sequence; and (iv) a power source in electrical connection to the means for amplifying the first signals and the means for providing encoding logic.

### CROSS-REFERENCE TO RELATED APPLICATIONS

This application claims the benefit of priority to U.S. Application No. 60/640,099, entitled “LED Security Device and System,” which was filed on Dec. 28, 2004, the entire disclosure of which is hereby incorporated by reference as if set forth at length herein.

### FIELD OF THE INVENTION

The present invention relates, in general, to light emitting diode (LED) technology. More specifically, this invention relates to a security device and a security system which employs LED technology, and methods of using such a security device and security system.

### BACKGROUND OF THE INVENTION

Many solar cells and LEDs are made of the same materials and work on the same principles. Solar cells convert light energy into electricity. Like solar cells in reverse, LEDs convert electricity into light energy. However, LEDs can only generate light at a specific frequency (color). Shining light into an LED produces some power, however they can only generate electricity from that same frequency of light that they generate when they are used as light sources. LEDs are therefore frequency specific light sensors. Just as an LED only creates light when a certain voltage threshold is crossed, the LED only produces electricity when a certain luminosity threshold is achieved.

### SUMMARY OF THE INVENTION

The present invention utilizes the ability of a “distinct” LED to emit and respond exclusively to only certain specific wavelengths of light. A distinct LED is capable of producing a single frequency of light within, for example, a +/−40 nm tolerance. Although other distinct LEDs exist today, the most commonly available distinct and super-bright LEDs are the red, blue, green, orange and infrared LEDs.

By having a plurality of distinct LEDs in close proximity (such as infrared, red, orange-red, orange, amber, yellow, yellow-green, green, blue-green, blue, blue-violet, violet or ultraviolet LEDs, etc.), a specific wavelength of light can be identified. For example, if a green LED is used to illuminate an array of green, red, blue, orange and infrared LEDs, the green LED would register a charge and the red, blue, orange and infrared LEDs would not. This creates a simple yet precise electric “code” that identifies a green light. Infrared, orange, red and blue light can be identified in the same way. By having identical electronic programs in the both the “key” and the “lock” a recognition protocol is established.

There can be multiple sequences or combinations of light colors with controlled pulse length and light intensity. Two or more colors can also be emitted and recognized at the same time. The result is a non-mechanical recognition mechanism with unlimited permutations.

Lasers are frequency specific light sources and as such can be used as “keys” for this system.

Therefore, in accordance with one aspect of the present invention, there is provided a security device comprising: (a) a plurality of light emitting diodes capable of receiving light having specific wavelengths and generating corresponding first electrical signals; (b) a component for amplifying the first electrical signals; (c) a component for providing encoding logic, wherein the component for providing encoding logic receives the amplified first electrical signals, determines whether the amplified first electrical signals correspond to a predetermined encoded sequence, and provides at least a second signal if the amplified first electrical signals correspond to the predetermined encoded sequence; and (d) a power source in electrical connection to the component for amplifying the first signals and the component for providing encoding logic.

In one embodiment, the light emitting diodes include red, blue, green, orange or infrared light emitting diodes, or a combination thereof.

In a second embodiment, the component for amplifying the first electrical signals is an amplification circuit.

In a third embodiment, the amplification circuit comprises a potentiometer.

In a fourth embodiment, the component for providing encoding logic is a programmable interrupt controller.

In accordance with an additional aspect of the present invention, there is provided a security system comprising: (a) a first device comprising a component for generating light having specific wavelengths; and (b) a second device comprising: (i) a plurality of light emitting diodes capable of receiving light having specific wavelengths and generating corresponding first electrical signals; (ii) a component for amplifying the first electrical signals; (iii) a component for providing encoding logic, wherein the component for providing encoding logic receives the amplified first electrical signals, determines whether the amplified first electrical signals correspond to a predetermined encoded sequence, and provides at least a second signal if the amplified first electrical signals correspond to the predetermined encoded sequence; and (iv) a power source in electrical connection to the component for amplifying the first signals and the component for providing encoding logic.

In accordance with an additional aspect of the present invention, there is provided a method of using a security system comprising: (a) providing a first device comprising a component for generating light having specific wavelengths; (b) providing a second device comprising: (i) a plurality of light emitting diodes capable of receiving light having specific wavelengths and generating corresponding first electrical signals; (ii) a component for amplifying the first electrical signals; (iii) a component for providing encoding logic, wherein the component for providing encoding logic receives the amplified first electrical signals, determines whether the amplified first electrical signals correspond to a predetermined encoded sequence, and provides at least a second signal if the amplified first electrical signals correspond to the predetermined encoded sequence; and (iv) a power source in electrical connection to the a component for amplifying the first signals and the component for providing encoding logic; (c) generating light having specific wavelengths from the first device, such that the light generated is received by the light emitting diodes of the second device, and the light emitting diodes generate corresponding first electrical signals; (d) amplifying the first electrical signals and providing the amplified first electrical signals to the component for providing encoding logic, such that the component for providing encoding logic determines whether the amplified first electrical signals correspond to a predetermined encoded sequence; and (e) providing at least a second signal from the component for providing encoding logic if the amplified first electrical signal corresponds to the predetermined encoded sequence.

In accordance with another aspect of the present invention, one of the LEDs employed may be used to restart the combination of light colors used in the system. For example, in one embodiment an infrared LED may be used to restart the combination of light colors used in the system by exposing the infrared LED to infrared radiation, thereby generating an electronic signal to appropriate circuitry to cause the security system to restart.

The preceding and other aspects, features and advantages of the present invention will become better understood with regard to the following description, appended claims, and accompanying drawings.

### BRIEF DESCRIPTION OF THE DRAWINGS

FIG. 1 depicts certain aspects of the prior art.

FIG. 2 depicts additional aspects of the prior art.

FIG. 3 depicts still further aspects of the prior art.

FIG. 4 depicts a schematic diagram of an exemplary embodiment of an LED security system in accordance with the present invention.

FIG. 5 depicts a logic flow diagram in accordance with the exemplary embodiment of FIG. 4 of the present invention.

### DETAILED DESCRIPTION OF THE INVENTION

The aspects, features and advantages of the present invention will become better understood with regard to the following description with reference to the accompanying drawings. What follows are preferred embodiments of the present invention. It should be apparent to those skilled in the art that these embodiments are illustrative only and not limiting, having been presented by way of example only. All the features disclosed in this description may be replaced by alternative features serving the same purpose, and equivalents or similar purpose, unless expressly stated otherwise. Therefore, numerous other embodiments of the modifications thereof are contemplated as falling within the scope of the present invention as defined herein and equivalents thereto.

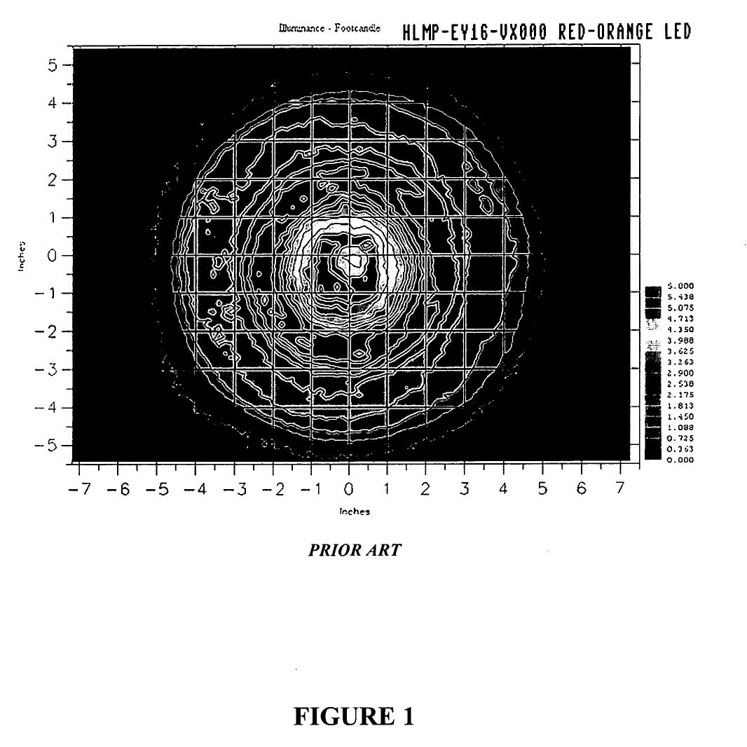

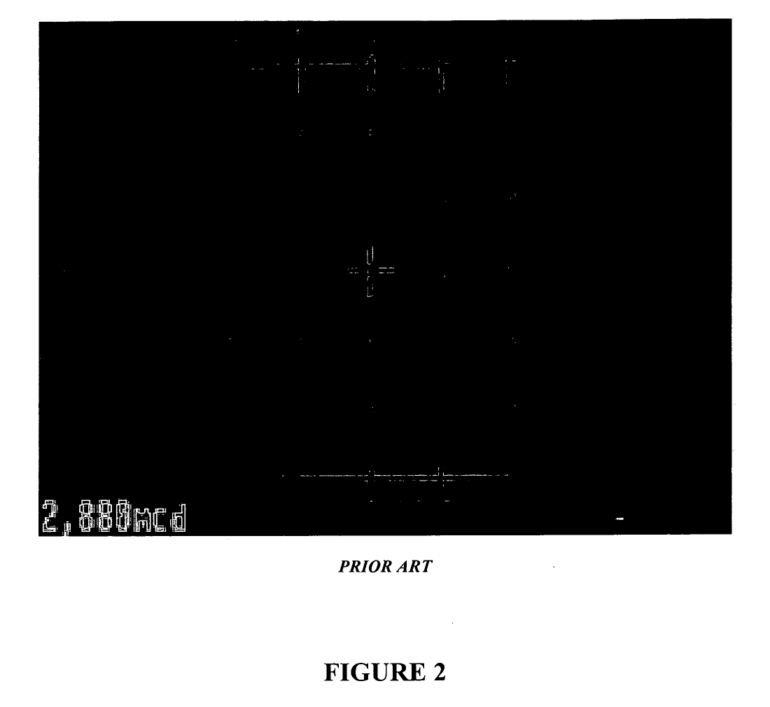

LEDs are directional and normally have a 45 degree radial sweep of output. FIG. 1 depicts a red-orange LED. Here, the red orange LED is a 660 nm LED. Other nanometer ranges are available in the red part of the spectrum. As shown, the intensity of the LED is focused primarily in the center and trails off very quickly beyond a six inch diameter circle. FIG. 2 illustrates the red-orange LED of FIG. 1 being tested on a ProMetric® Beam Profile Analysis device (a light measuring instrument by Radiant Imaging, Inc. of Duvall, Wash.) from approximately 22.5 inches away.

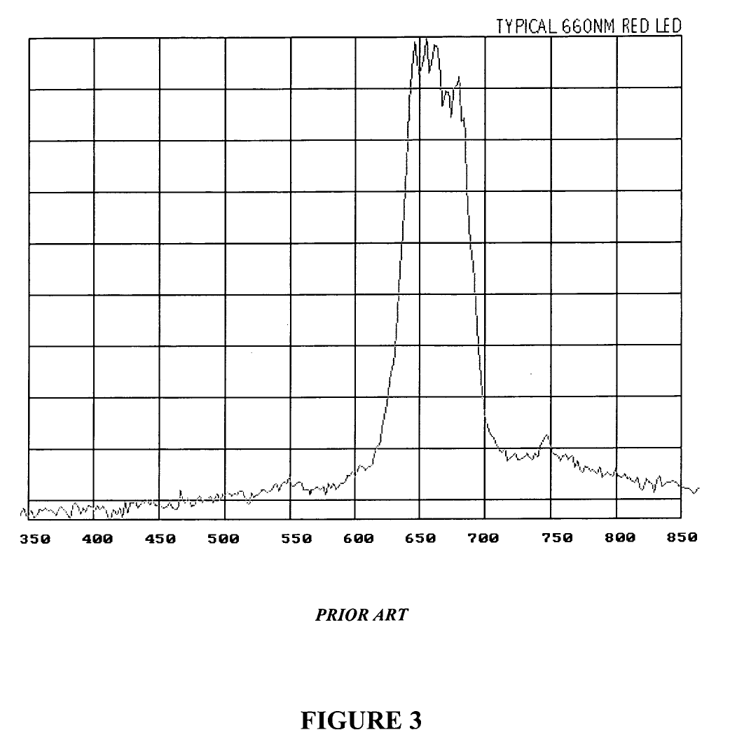

LEDs are only capable of emitting very specific wavelengths of light. Thus, a red LED has an intense red color. FIG. 3 is a graph of intensity plotted against wavelength. Note the tremendous spike that begins at around 640 nm to 680 nm and centered at 660 nm. This spike illustrates the LED's tendency towards a single frequency. The small spikes across the bottom are merely noise in the instrument.

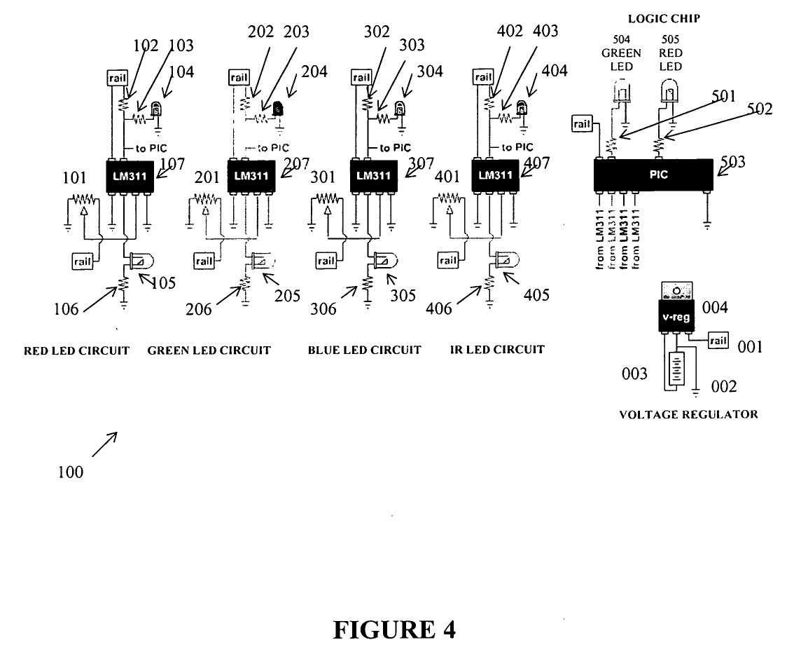

FIG. 4 illustrates a schematic of an exemplary embodiment of an LED system according to the present invention. In the embodiment shown, LED system 100 comprises a voltage regulator, a logic chip, a red LED circuit, a blue LED circuit, a green LED circuit, an infrared LED circuit and a shared power source (rail). Each LED circuit includes a pair of LEDs and each pair of LEDs comprises a small receptor LED and a large signal LED. Preferably, one or more potentiometers are included for fine-tuning the sensitivity of an associated LED. The power source can comprise solar cells, capacitors and battery power. A voltage regulator controls the flow of current and voltage within the system.

Referring more specifically to FIG. 4, a 5-volt voltage regulator 004 is electrically connected to a 9-volt battery 003, a rail 001 and ground 002. The rail 001 refers to the positive element of the 5-volt power source and the ground 002 refers to the negative element of the power source.

The PIC logic chip 503 (which may also be replaced with a Programmable Logic Device or other similar logic device) is electrically connected to and receives 5-volt signals from voltage comparators 107, 207, 307 and 407. A green LED 504 is electrically connected to a 330 Ω resistor 501. The resistor 501 is electrically connected to the PIC 503. A red LED 505 is electrically connected to a 330 Ω resistor 502. The PIC 503 includes program instructions to determine whether to transmit a “locked” or “unlocked” signal. The red LED 505 will remain on until the PIC 503 interrupts it. Specifically, after the PIC 503 determines an unlocked state, the PIC 503 will interrupt the red LED 505, the red LED 505 will turn off and the green LED 504 will turn on. The result is an optical display that can be understood as “red for locked” and “green for unlocked.”

In the red LED circuit diagram, the rail 001 is electrically connected to a 1000 Ω resistor 102, the LM311 voltage comparator 107 and a 100 KΩ potentiometer 101. The resistor 102 and the potentiometer 101 comprise a simple circuit called a voltage divider. The voltage divider allows analog control over the voltage value at the end of the potentiometer 101. This attenuated signal is then fed to the voltage comparator 107, which sets the signal as the voltage threshold. The resulting circuit is an amplifier that compares the low-voltage signal from a red LED 105 to the voltage threshold value and sends a 5-volt signal to the logic chip device 503 if the low-voltage signal from the red LED 105 crosses the threshold value. A 1000 KΩ resistor 106 connects the LED 105 to the ground 002. The 1000 Ω resistor 103 and a red LED 104 are electrically connected to the resistor 102. The resistor 102 is electrically connected to rail 001. The red LED 104 will remain on until it is interrupted by an optical input at the red LED 105. This allows for proper attenuation of the red LED circuit's sensitivity.

Similar to the red LED circuit, in the green LED circuit diagram, the rail 001 is electrically connected to a 2000 Ω resistor 202, the LM311 voltage comparator 207 and a 200 KΩ potentiometer 201. The resistor 202 and the potentiometer 201 comprise a voltage divider, which allows analog control over the voltage value at the end of the potentiometer 201. This attenuated signal is fed to the voltage comparator 207. The voltage comparator 207 sets the signal as the voltage threshold. The resulting amplifier compares the low-voltage signal from a green LED 205 to the voltage threshold value and sends a 5-volt signal to the logic device 503 if the low voltage signal crosses the threshold value. A 2000 KΩ resistor 206 connects the green LED 205 to the ground 002. A 2000 Ω resistor 203 and a green LED 204 are electrically connected to the resistor 202. The resistor 202 is electrically connected to the rail 001. The green LED 204 will remain on until it is interrupted by an optical input at the green LED 205. This allows for proper attenuation of the green LED circuit's sensitivity.

Similar to the red and green LED circuits, in the blue LED circuit diagram, the rail 001 is electrically connected to a 3000 Ω resistor 302, the LM311 voltage comparator 307 and a 300 KΩ potentiometer 301. The resistor 302 and the potentiometer 301 comprise a voltage divider, which allows analog control over the voltage value at the end of the potentiometer 301. This attenuated signal is fed to the voltage comparator 307. The voltage comparator sets the signal as the voltage threshold. The resulting amplifier compares the low-voltage signal from the blue LED 305 to the voltage threshold value and sends a 5-volt signal to the logic device 503 if the low-voltage signal crosses the threshold value. A 3000 KΩ resistor 306 connects a blue LED 305 to the ground 002. A 3000 Ω resistor 303 and a blue LED 304 are electrically connected to the resistor 302. The resistor is electrically connected to the rail 001. The blue LED 304 will remain on until it is interrupted by an optical input at the blue LED 305. This allows for proper attenuation of the blue LED circuit's sensitivity.

Lastly, in the infrared LED circuit diagram, the rail 001 is electrically connected to a 4000 Ω resistor 402, the LM311 voltage comparator 407 and a 400 KΩ potentiometer 401. The resistor 402 and the potentiometer 401 comprise a voltage divider. The voltage divider allows analog control over the voltage value at the end of the potentiometer 401. This attenuated signal is fed to the voltage comparator 407. The voltage comparator 407 sets the fed signal as the voltage threshold. The resulting amplifier compares the low-voltage signal from an infrared LED 405 to the voltage threshold value and sends a 5-volt signal to the logic device 503 if the voltage signal crosses the threshold value. A 4000 KΩ resistor 406 connects the infrared LED 405 to the ground 002. A 4000 Ωresistor 403 and an infrared LED 404 are electrically connected to resistor 402. The resistor 402 is electrically connected to the rail 001. The infrared LED 404 will remain on until it is interrupted by an optical input at the infrared LED 405. This allows for proper attenuation of the infrared LED circuit's sensitivity.

A specific implementation of the LED system 100 comprises a handheld device (“remote control”) and a unit that is remotely controlled by the handheld device (“controlled unit”). The controlled unit can be permanently wall-mounted. The remote control and the controlled unit each have logic chips, which are preferably programmable interrupt controller chips (PIC) having programmable logic stored in the chip's memory unit. The remote control further includes a transmitter component for transmitting pulses of LED light that represent encoded signal information. The controlled unit includes a receiver component for receiving the encoded signals.

Specifically, the LED remote control (via the transmitter) sends out pulses of LED light that represent specific binary codes. The binary codes correspond to predefined commands. The receiver in the controlled unit decodes the pulses of light into the binary data (ones and zeroes) that the controlled unit's PIC chip can understand. The controlled unit's PIC chip then carries out the corresponding command.

Each LED pair is arranged in an asymmetrical pattern to distinguish the remote control and the controlled unit orientations. During use, the remote control fires off a sequence of lights quickly enough to fool the human eye into seeing only a flicker but slowly enough for the controlled unit to recognize the pattern.

In another embodiment, lasers may be used as frequency specific light sources to trigger a corresponding LED in the receiver. For example, lasers are typically operable at 635 nm for the color red. Thus, a system utilizing a 635 nm laser to trigger a red LED would include a receiver device having a 635 nm LED. The same principle applies for lasers which generate light of other wavelengths.

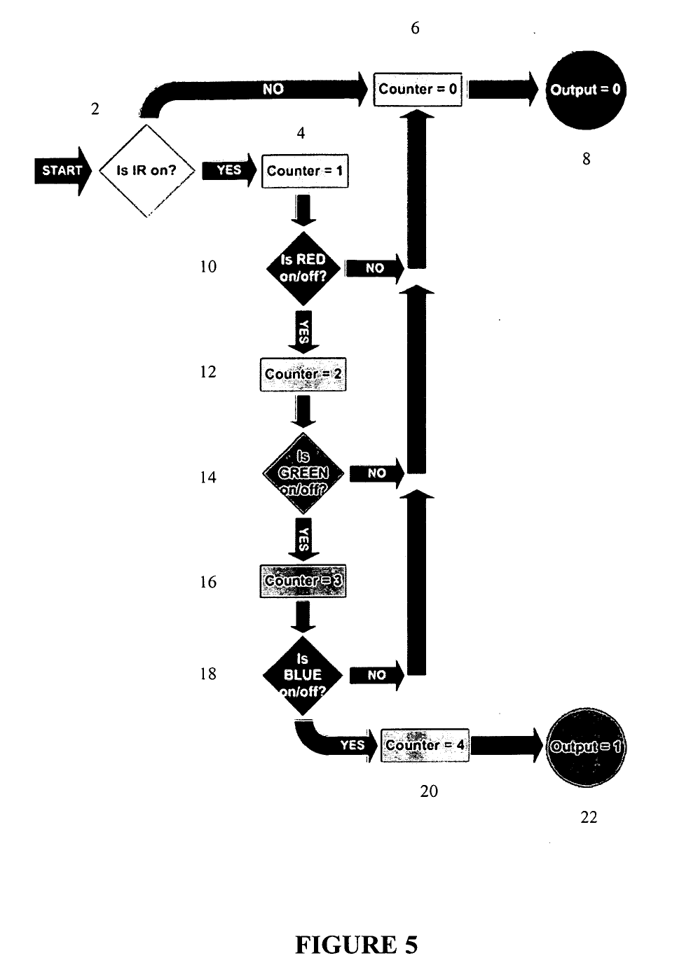

FIG. 5 illustrates the process flow of the LED system 100 chip logic of FIG. 1. The PIC chip is configured to interpret incoming light signals and to store the combination of light signals in the PIC chip's memory.

At 2, the chip determines if the infrared (IR) is on. If yes, process flow continues to step 4. If no, process flow continues to step 6 where the counter is set to 0. Thereafter, at 8, output is set to 0.

At 4, the counter is incremented to 1. At 10, the chip determines if RED is on. If yes, process continues to step 12. If no, process continues to step 6. At 6, the counter is set to 0 and at 8, output is set to 0.

At 12, the counter is incremented to 2. At 14, the chip determines if GREEN is on. If yes, process continues to step 16. If no, process continues to step 6. At 6, the counter is set to 0 and at 8, output is set to 0.

At 16, the counter is incremented to 3. At 18, the chip determines if GREEN is on. If yes, process continues to step 20. If no, process continues to step 6. At 16, the counter is set to 0 and at 8, output is set to 0.

At 20, the counter is incremented to 4. Finally at 22, output is set to 1.

The present invention is capable of infinite permutations because the code relies on n infinitely independent variables. For simplicity, the exemplary LED system 100 of FIG. 4 and FIG. 5 has one PIC chip associated with four LED circuits (i.e., IR, red, green and blue). The PIC chip is capable of storing a combination that is seven digits in length. The infrared LED pair operates solely to restart a chosen code and the red, green and blue LED pairs represent a binary display. The red, green and blue LED pairs provide seven possible digits (i.e., 0-6) to “display” the chosen code. There are seven distinct outcomes ranging from all LED pairs being off and all being on. In a preferred embodiment, the all LED pairs off position is not used. Therefore, the three LED pairs represent a six digit number pad. Using a seven-code sequence, there are 823,543 permutations. Using a 100 digit code sequence, there are 3.23447651×10⁸⁴ permutations.

In other embodiments, the LED system 100 may include additional pairs of LEDs and a larger memory unit thereby expanding the digit combinations and capabilities of the system. For example, an LED system 100 having six LED pairs represents a 63 digit number pad. If a seven digit code sequence is used, there are 3,938,980,639,167 permutations and with a 100 code sequence, there are 8.59122208×10¹⁷⁹ permutations.

One of the target markets for the present invention is the hotel industry. Hotels currently use keys or keycards for guest access, however the keys or keycards are not aesthetically pleasing or foolproof. Keys are susceptible to loss, necessitating the replacement of the entire lock. The present invention remote technology opens up a visually pleasing alternative that is completely secure.

Additional alternative uses exist. For example, a secure large bandwidth line-of sight communications device can be built using the present invention's technology. A series of lasers can shine across a distance to their complementary LEDs and create multiple communication channels resulting in a large bandwidth connection because each LED would serve as its own channel. For example, a system having red, green and blue LEDs would comprise a three-channel communication system. Such a system enables wireless transmission of large data files, e.g., maps, itineraries and similar secure documents, which is particularly useful on a battlefield where the most common communications devices are radios and satellites, neither of which are very secure.

The present invention can also be used for ATM banking transactions. ATMs are used nationwide. Debit cards store only a few critical pieces of information like account number and some personal information. The present invention's remote control storage capability is limited only by cost and size. The remote control can also be attached to a cell-phone or personal digital assistant (PDA) as a peripheral device. The remote control will not only send the ATM a user's account number, but also allow the user to conduct certain transactions on a PDA, such as paying bills or wiring money. The remote control can carry personal information, including name, address and telephone number which can expedite processes like making deposits or withdrawals that require a user to fill out slips of paper. A receiver similar to a modern credit card reader can be flashed with all the necessary information. The user signs the receiver with the attached stylus to conclude the transaction.

The system of the present invention can also operate as a security clearance device to, e.g., enable authorized individuals with the proper clearance to access restricted locations. During use, the system acquires and stores individual contact information, physical descriptions and an identification photo, information that can be accessed immediately.

Having now described preferred embodiments of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. For example, the resistors used in the device may be variable or permanent. Such changes and modifications can be made without departing from the spirit and scope of this invention and without diminishing its attendant advantages. Therefore, numerous other embodiments of the modifications thereof are contemplated as falling within the scope of the present invention as defined by the appended claims and equivalents thereto. It is therefore intended that such changes and modifications be covered by the appended claims.

What is claimed is:

1. A security device comprising:
(a) a plurality of light emitting diodes capable of receiving light having specific wavelengths and generating corresponding first electrical signals;
(b) means for amplifying the first electrical signals;
(c) means for providing encoding logic, wherein the means for providing encoding logic receives the amplified first electrical signals, determines whether the amplified first electrical signals correspond to a predetermined encoded sequence, and provides at least a second signal if the amplified first electrical signals correspond to the predetermined encoded sequence; and
(d) a power source in electrical connection to the means for amplifying the first signals and the means for providing encoding logic.

2. The security device of claim 1, wherein each of the plurality of light emitting diodes comprise a distinct color.

3. The security device of claim 1, in which the light emitting diodes are selected from red, blue, green, orange or infrared light emitting diodes, or a combination thereof.

4. The security device of claim 1, in which the means for amplifying the first electrical signals is an amplification circuit.

5. The security device of claim 1, in which the amplification circuit comprises a potentiometer.

6. The security device of claim 1, in which the means for providing encoding logic is a programmable interrupt controller.

7. A security system comprising:
(a) a first device comprising means for generating light having specific wavelengths; and
(b) a second device comprising:
i. a plurality of light emitting diodes capable of receiving light having specific wavelengths and generating corresponding first electrical signals,
ii. means for amplifying the first electrical signals,
iii. means for providing encoding logic, wherein the means for providing encoding logic receives the amplified first electrical signals, determines whether the amplified first electrical signals correspond to a predetermined encoded sequence, and provides at least a second signal if the amplified first electrical signals correspond to the predetermined encoded sequence, and
iv. a power source in electrical connection to the means for amplifying the first signals and the means for providing encoding logic.

8. A method of using a security system comprising:
(a) providing a first device comprising means for generating light having specific wavelengths;
(b) providing a second device comprising:
i. a plurality of light emitting diodes capable of receiving light having specific wavelengths and generating corresponding first electrical signals,
ii. means for amplifying the first electrical signals,
iii. means for providing encoding logic, wherein the means for providing encoding logic receives the amplified first electrical signals, determines whether the amplified first electrical signals correspond to a predetermined encoded sequence, and provides at least a second signal if the amplified first electrical signals correspond to the predetermined encoded sequence, and
iv. a power source in electrical connection to the means for amplifying the first signals and the means for providing encoding logic;
(c) generating light having specific wavelengths from the first device, such that the light generated is received by the light emitting diodes of the second device, and the light emitting diodes generate corresponding first electrical signals;
(d) amplifying the first electrical signals and providing the amplified first electrical signals to the means for providing encoding logic, such that the means for providing encoding logic determine whether the amplified first electrical signals correspond to a predetermined encoded sequence; and
(e) providing at least a second signal from the means for providing encoding logic if the amplified first electrical signal corresponds to the predetermined encoded sequence.

9. A security device comprising:
(a) a plurality of light emitting diodes capable of receiving light having specific wavelengths and generating corresponding first electrical signals;
(b) a first component for amplifying the first electrical signals;
(c) a second component for providing encoding logic, wherein the second component receives the amplified first electrical signals, determines whether the amplified first electrical signals correspond to a predetermined encoded sequence, and provides at least a second signal if the amplified first electrical signals correspond to the predetermined encoded sequence; and
(d) a power source in electrical connection to the first component and the second component.

10. The security device of claim 9, wherein each of the plurality of light emitting diodes comprise a distinct color.

11. The security device of claim 10, in which the light emitting diodes are selected from red, blue, green, orange or infrared light emitting diodes, or a combination thereof.

12. The security device of claim 9, in which the first component is an amplification circuit.

13. The security device of claim 12, in which the amplification circuit comprises a potentiometer.

14. The security device of claim 9, in which the second component is a programmable interrupt controller.

15. A security system comprising:
(a) a first device comprising a third component for generating light having specific wavelengths; and
(b) a second device comprising:
i. a plurality of light emitting diodes capable of receiving light having specific wavelengths and generating corresponding first electrical signals,
ii. a first component for amplifying the first electrical signals,
iii. a second component for providing encoding logic, wherein the second component receives the amplified first electrical signals, determines whether the amplified first electrical signals correspond to a predetermined encoded sequence, and provides at least a second signal if the amplified first electrical signals correspond to the predetermined encoded sequence, and
iv. a power source in electrical connection to the first component and the second component.

16. A method of using a security system comprising:
(a) providing a first device comprising a third component for generating light having specific wavelengths;
(b) providing a second device comprising:
i. a plurality of light emitting diodes capable of receiving light having specific wavelengths and generating corresponding first electrical signals,
ii. a first component for amplifying the first electrical signals,
iii. a second component for providing encoding logic, wherein the second component receives the amplified first electrical signals, determines whether the amplified first electrical signals correspond to a predetermined encoded sequence, and provides at least a second signal if the amplified first electrical signals correspond to the predetermined encoded sequence, and
iv. a power source in electrical connection to the first component and the second component;
(c) generating light having specific wavelengths from the first device, such that the light generated is received by the light emitting diodes of the second device, and the light emitting diodes generate corresponding first electrical signals;
(d) amplifying the first electrical signals and providing the amplified first electrical signals to the second component, such that the second component determines whether the amplified first electrical signals correspond to a predetermined encoded sequence; and
(e) providing at least a second signal from the second component if the amplified first electrical signal corresponds to the predetermined encoded sequence.
